(19) United States
(12) Patent Application Publication
(10) Pub. No.: US 2025/0392210 A1
(43) Pub. Date: Dec. 25, 2025

(54) SWITCHING POWER SUPPLY

(71) Applicant: Murata Manufacturing Co., Ltd., Kyoto-fu (JP)

(72) Inventors: Hiroyuki TAKATSUJI, Nagaokakyo-shi (JP); Tatsuya HOSOTANI, Nagaokakyo-shi (JP)

(73) Assignee: Murata Manufacturing Co., Ltd., Kyoto-fu (JP)

(21) Appl. No.: 19/313,147

(22) Filed: Aug. 28, 2025

Related U.S. Application Data
(63) Continuation of application No. PCT/JP2024/008202, filed on Mar. 5, 2024.

(30) Foreign Application Priority Data
Mar. 13, 2023 (JP) 2023-038587

(51) Int. Cl. H02M 1/44; H02M 3/158

(52) U.S. Cl. CPC H02M 1/44; H02M 3/158

(57) ABSTRACT

A circuit board includes first and second wiring patterns. The first wiring pattern electrically connects a node between switching elements to a first terminal. The second wiring pattern electrically connects a second terminal to an output capacitor. An inductor includes first and second windings, and a magnetic core. The first winding is near the circuit board. The second winding is farther from the circuit board than is the first winding, and connected in series with the first winding. The first and second windings are contained in the magnetic core. The first winding is electrically connected to the first terminal. The second winding is electrically connected to the second terminal. The first wiring pattern has an area smaller than a projected area of the inductor in physical size. The second wiring pattern has an area substantially equal to or larger than the projected area of the inductor in physical size.

### CROSS-REFERENCE TO RELATED APPLICATIONS

This application claims benefit of priority to International Patent Application No. PCT/JP2024/008202, filed Mar. 5, 2024, and to Japanese Patent Application No. 2023-038587, filed Mar. 13, 2023, the entire contents of each are incorporated herein by reference.

### BACKGROUND

### Technical Field

The present disclosure relates to a switching power supply including a switching element for power conversion.

### Background Art

Japanese Unexamined Patent Application Publication No. 2018-98853 describes a DC-DC converter. The DC-DC converter in Japanese Unexamined Patent Application Publication No. 2018-98853 includes a switching element, and an inductor connected to the output side of the switching element. The DC-DC converter in Japanese Unexamined Patent Application Publication No. 2018-98853 also includes a shield member.

The switching element, the inductor, and the shield member are mounted to a substrate. The shield member is disposed at the substrate so as to surround the inductor.

### SUMMARY

The presence of the shield member not related to power conversion, however, leads to an unwanted increase in the size of the DC-DC converter (switching power supply). If no shield member is present in the case of the configuration described in Japanese Unexamined Patent Application Publication No. 2018-98853, EMI noise generated from the inductor is radiated or conducted to the external environment.

Accordingly, the present disclosure provides a high-efficiency and compact switching power supply configured to reduce radiation of switching noise and reduce common-mode noise that is conducted to the chassis due to the radiation.

A switching power supply according to the present disclosure includes an input capacitor, a first switching element, a second switching element, an inductor, an output capacitor, and a circuit board. The first switching element and the second switching element are electrically connected to the input capacitor. The inductor includes a first terminal and a second terminal. The input capacitor, the first switching element, the second switching element, the inductor, and the output capacitor are mounted to the circuit board.

The circuit board includes a first wiring pattern, and a second wiring pattern. The first wiring pattern electrically connects a connection node between the first switching element and the second switching element to the first terminal. The second wiring pattern electrically connects the second terminal to the output capacitor.

The inductor includes a first winding, a second winding, and a magnetic core. The first winding is disposed near the circuit board. The second winding is disposed farther from the circuit board than is the first winding, and connected in series with the first winding. The first winding and the second winding are contained in the magnetic core. The first winding is electrically connected to the first terminal. The second winding is electrically connected to the second terminal.

The first wiring pattern has an area smaller than a projected area of the inductor in physical size. The second wiring pattern has an area substantially equal to or larger than the projected area of the inductor in physical size.

According to the configuration mentioned above, the input capacitor, the first wiring pattern, the second wiring pattern, and the output capacitor constitute a noise-balancing circuit. The noise-balancing circuit is capable of canceling generation of electromagnetic noise caused by the switching operation of the first switching element and the second switching element, and reducing generation of common-mode noise which occurs as electric-field noise radiated from the first winding of the inductor couples to a reference ground (chassis).

The present disclosure makes it possible to provide a high-efficiency and compact switching power supply including a noise-balancing circuit formed without use of a noise reduction component, the noise-balancing circuit being configured to cancel generation of electromagnetic noise caused by switching operation and to reduce common-mode noise that is conducted through the chassis due to radiation or conduction of switching noise.

### BRIEF DESCRIPTION OF THE DRAWINGS

FIG. 1 is a circuit diagram illustrating a schematic configuration of a switching power supply according to a first embodiment of the present disclosure;

FIG. 2 is an equivalent circuit diagram of an inductor according to the first embodiment of the present disclosure;

FIG. 3A is a plan view of the inductor according to the first embodiment of the present disclosure, and FIG. 3B is a side view of the inductor;

FIG. 4A is a see-through plan view of the inductor according to the first embodiment of the present disclosure, illustrating the configuration of its winding conductors, FIG. 4B is a see-through side view of the inductor illustrating the configuration of the winding conductors, and FIGS. 4C and 4D are each a see-through plan view of the corresponding one of the winding conductors;

FIG. 5A is a plan view of the switching power supply according to the first embodiment of the present disclosure, illustrating its configuration including a mounting portion where the inductor is mounted, and FIG. 5B is a side cross-sectional view of the switching power supply thereof;

FIG. 6 schematically illustrates the flow of EMI noise in the switching power supply according to the first embodiment of the present disclosure;

FIG. 7 schematically illustrates the flow of EMI noise in a switching power supply according to a comparative configuration;

FIG. 8A is a graph illustrating levels of conducted noise according to the present configuration and the comparative configuration, and FIG. 8B is a graph illustrating levels of radiated noise according to the present configuration and the comparative configuration;

FIG. 9 is a side cross-sectional view of a switching power supply according to a second embodiment of the present disclosure, illustrating its configuration including a mounting portion where the inductor is mounted;

FIG. 10 is a side cross-sectional view of a switching power supply according to a third embodiment of the present disclosure, illustrating its configuration including a mounting portion where the inductor is mounted;

FIG. 11 is an equivalent circuit diagram of a switching power supply according to a third embodiment of the present disclosure;

FIG. 12 is a side cross-sectional view of a switching power supply according to a fourth embodiment of the present disclosure, illustrating its configuration including a mounting portion where the inductor is mounted;

FIG. 13 is a see-through side view of an inductor according to a fifth embodiment of the present disclosure, illustrating the configuration of its winding conductors;

FIGS. 14A and 14B are see-through plan views of an inductor according to a sixth embodiment of the present disclosure, each illustrating the corresponding one of its winding conductors;

FIG. 15 is a see-through side view of an inductor according to a seventh embodiment of the present disclosure, illustrating the configuration of its winding conductors;

FIG. 16A is a side view of an inductor according to an eighth embodiment of the present disclosure illustrating its configuration, and FIG. 16B conceptually illustrates the inductor with conductor patterns wound around a magnetic core;

FIG. 17 is a side view of an inductor according to a ninth embodiment of the present disclosure illustrating its configuration; and

FIG. 18 is a circuit diagram illustrating a schematic configuration of a switching power supply according to a tenth embodiment of the present disclosure.

### DETAILED DESCRIPTION

### First Embodiment

A switching power supply according to a first embodiment of the present disclosure will now be described with reference to the drawings.

### Configuration of Switching Power Supply 10

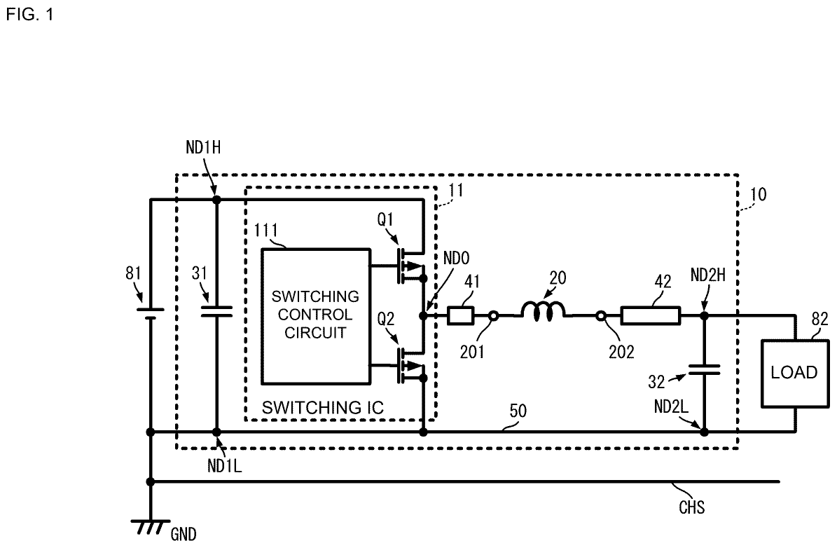

FIG. 1 is a circuit diagram illustrating a schematic configuration of a switching power supply according to a first embodiment of the present disclosure.

As illustrated in FIG. 1, a switching power supply 10 includes a switching IC 11, an inductor 20, an input capacitor 31, and an output capacitor 32. The switching IC 11 includes a switching control circuit 111, a switching element Q1, and a switching element Q2. The switching element Q1 corresponds to a “first switching element”, and the switching element Q2 corresponds to a “second switching element.” The switching element Q1 and the switching element Q2 are each a power semiconductor element, and implemented by, for example, an N-type MOS-FET.

The switching power supply 10 is electrically connected to a direct-current power source 81, and electrically connected to a load 82.

More specifically, the input capacitor 31 is electrically connected in parallel with the direct-current power source 81. The connection point between the positive terminal of the direct-current power source 81 and the input capacitor 31 is a node ND1H, and the connection point between the negative terminal of the direct-current power source 81 and the input capacitor 31 is a node ND1L.

The switching element Q1 and the switching element Q2 are electrically connected in series with each other. More specifically, the source of the switching element Q1, and the drain of the switching element Q2 are electrically connected to each other. The connection point between the switching element Q1 and the switching element Q2 is a node NDO.

The switching element Q1 and the switching element Q2 are electrically connected to the input capacitor 31. More specifically, the drain of the switching element Q1 is connected to the node ND1H at the high side of the input capacitor 31. The source of the switching element Q2 is connected to the node NDIL at the low side of the input capacitor 31.

The switching control circuit 111 is electrically connected to the gate of the switching element Q1 and the gate of the switching element Q2. The switching element Q1 and the switching element Q2 switch the electrical conduction between the drain and the source on or off in response to a switching control signal provided from the switching control circuit 111.

The inductor 20 includes a first terminal 201, and a second terminal 202. Descriptions of specific electrical and physical configurations of the inductor 20, and specific wiring patterns connected to the inductor 20 will be given later, and are omitted here.

The first terminal 201 of the inductor 20 is connected to the node NDO of the switching IC 11. One terminal (high-side terminal) of the output capacitor 32 is connected to the second terminal 202 of the inductor 20. The connection point between the second terminal 202 of the inductor 20 and the one terminal of the output capacitor 32 is a node ND2H.

The other terminal (low-side terminal) of the output capacitor 32 is connected to a reference-potential-side wiring pattern 50. The connection point between the other terminal of the output capacitor 32 and the reference-potential-side wiring pattern 50 is a node ND2L.

The reference-potential-side wiring pattern 50 is connected to the node ND1L (the connection point between the negative terminal of the direct-current power source 81 and the input capacitor 31).

Due to the configuration mentioned above, the switching power supply 10 is implemented as a step-down DC-DC converter.

The load 82 is electrically connected in parallel with the output capacitor 32. More specifically, one terminal of the load 82 is connected to the node ND2H, and the other terminal of the load 82 is connected to the node ND2L.

Further, the node ND1L (the connection point between the negative terminal of the direct-current power source 81 and the input capacitor 31) of the switching power supply 10 is electrically connected to a chassis CHS of, for example, a vehicle in which the switching power supply 10, the direct-current power source 81, and the load 82 are incorporated. The chassis CHS is connected to a ground potential as appropriate.

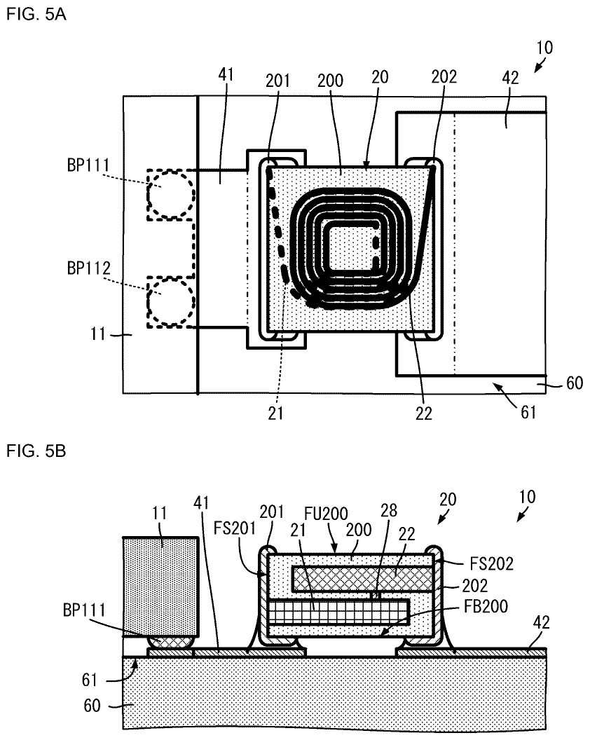

The switching IC 11, the inductor 20, the input capacitor 31, and the output capacitor 32 are each implemented by a mountable electronic component. Wiring patterns for implementing the above-mentioned circuit configuration of the switching power supply 10 are provided at a circuit board 60 (see FIG. 5B and other figures described later). The switching power supply 10 is implemented by mounting of the switching IC 11, the inductor 20, the input capacitor 31, and the output capacitor 32 to the circuit board 60. The resulting circuit board 60 is physically and electrically connected to the chassis CHS.

Specific Configuration of Inductor 20, and Specific Configuration of Wiring Patterns Connected to Inductor 20

### Equivalent Circuit of Inductor 20

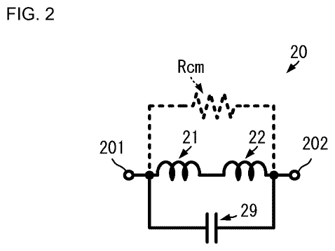

FIG. 2 is an equivalent circuit diagram of the inductor according to the first embodiment of the present disclosure. The inductor 20 includes a first winding 21, a second winding 22, the first terminal 201, and the second terminal 202. The first winding 21 and the second winding 22 are connected in series between the first terminal 201 and the second terminal 202.

The inductor 20 has a parasitic capacitor 29 connected between the first terminal 201 and the second terminal 202. In other words, the inductor 20 has the parasitic capacitor 29 connected in parallel with a series circuit of the first winding 21 and the second winding 22.

Further, the inductor 20 has, between the first terminal 201 and the second terminal 202, a resistive component Rcm due to a magnetic core.

### Specific Structure of Inductor 20

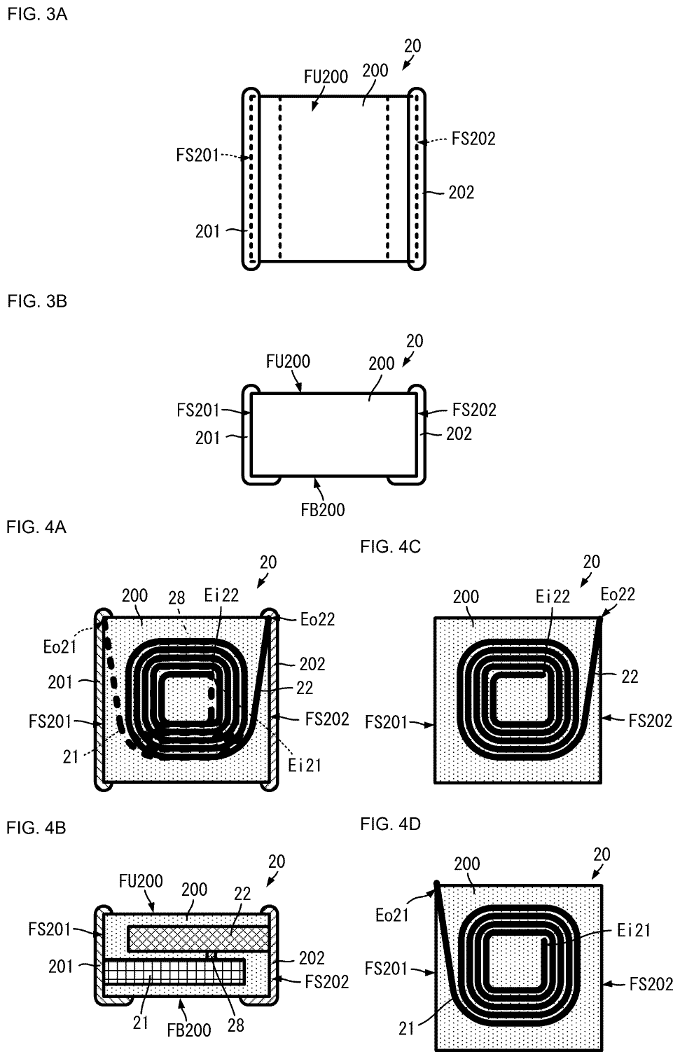

FIG. 3A is a plan view of the inductor according to the first embodiment of the present disclosure, and FIG. 3B is a side view of the inductor. FIG. 4A is a see-through plan view of the inductor according to the first embodiment of the present disclosure, illustrating the configuration of its winding conductors, FIG. 4B is a see-through side view of the inductor illustrating the configuration of the winding conductors, and FIGS. 4C and 4D are each a see-through plan view of the corresponding one of the winding conductors.

As illustrated in FIG. 3A, FIG. 3B, FIG. 4A, and FIG. 4B, structurally, the inductor 20 includes the first winding 21, the second winding 22, a magnetic core 200, the first terminal 201, and the second terminal 202.

The magnetic core 200 is substantially cuboid in shape. The magnetic core 200 includes a top face FU200, a bottom face FB200, a side face FS201, a side face FS202, and the other two side faces. The side face FS201 and the side face FS202 are opposite to each other. The other two side faces are opposite to each other, and orthogonal and connected to the side face FS201 and the side face FS202.

The first winding 21 has a coiled shape in plan view, and has a predetermined height. The height of the first winding 21 is greater than the thickness of a flat conductor constituting the first winding 21. The coiled shape of the first winding 21 includes an inner end portion Ei21, and an outer end portion Eo21.

The second winding 22 is similar in configuration to the first winding 21. The coiled shape of the second winding 22 includes an inner end portion Ei22, and an outer end portion Eo22.

The first winding 21 and the second winding 22 are contained in the magnetic core 200 such that the first winding 21 and the second winding 22 have a coiled shape in plan view. That is, the magnetic core 200 surrounds the first winding 21 and the second winding 22, and also fills the central opening of the coiled shape of each of the first winding 21 and the second winding 22.

The first winding 21 and the second winding 22 are stacked in the direction of height of the magnetic core 200. The first winding 21 is disposed closer to the bottom face FB200 than is the second winding 22. In other words, the first winding 21 and the second winding 22 are stacked in this order from the bottom face FB200 of the magnetic core 200 toward the top face FU200. Due to the configuration mentioned above, the first winding 21 and the second winding 22 capacitively couple to each other to form the parasitic capacitor 29.

The inner end portion Ei21 of the first winding 21, and the inner end portion Ei22 of the second winding 22 are connected by a connection conductor 28.

The outer end portion Eo21 of the first winding 21 is exposed on the side face FS201 of the magnetic core 200. The outer end portion Eo22 of the second winding 22 is exposed on the side face FS202 of the magnetic core 200.

The first terminal 201 made of an electric conductor is provided so as to extend from the side face FS201 of the magnetic core 200 to the bottom face FB200. The outer end portion Eo21 of the first winding 21 is thus electrically connected to the first terminal 201.

The second terminal 202 made of an electric conductor is provided so as to extend from the side face FS202 of the magnetic core 200 to the bottom face FB200. The outer end portion Eo22 of the second winding 22 is thus electrically connected to the second terminal 202.

The configuration described above is employed to implement the equivalent circuit of the inductor 20 illustrated in FIG. 2.

### Configuration of Wiring for Inductor 20

The circuit configuration of the wiring for the inductor 20 is as illustrated in FIG. 1.

The inductor 20 is connected to the switching IC 11 via a wiring pattern 41, and connected by the wiring pattern 42 to the one terminal of the output capacitor 32. More specifically, the first terminal 201 of the inductor 20 is connected via the wiring pattern 41 to the node NDO between the switching element Q1 and the switching element Q2. The second terminal 202 of the inductor 20 is connected via a wiring pattern 42 to the node ND2H at the high side of the output capacitor 32.

### Physical Configuration of Wiring for Inductor 20

FIG. 5A is a plan view of the switching power supply according to the first embodiment of the present disclosure, illustrating its configuration including a mounting portion where the inductor is mounted, and FIG. 5B is a side cross-sectional view thereof. FIG. 5A depicts the first winding 21 and the second winding 22 inside the inductor 20 in such a way as to reveal the internal wiring of the inductor 20.

The circuit board 60 includes an insulative substrate, and various conductor patterns provided at the insulative substrate. The circuit board 60 includes a surface 61. The switching IC 11, the inductor 20, the input capacitor 31, and the output capacitor 32 are mounted to the surface 61 of the circuit board 60. The various conductor patterns include the wiring pattern 41, the wiring pattern 42, and the reference-potential-side wiring pattern 50, and are provided at the circuit board 60 together with the switching IC 11, the inductor 20, the input capacitor 31, and the output capacitor 32 in such a way as to implement the circuit configuration of the switching power supply 10 illustrated in FIG. 1.

The specific structure of the mounting portion for the inductor 20 is as described below.

As illustrated in FIGS. 5A and 5B, the wiring pattern 41 and the wiring pattern 42, each of which is a conductor pattern, are provided on the surface 61 of the circuit board 60.

One end of the wiring pattern 41 is connected with a land to which the source terminal of the switching element Q1 of the switching IC 11 is mounted, and with a land to which the drain terminal of the switching element Q2 of the switching IC 11 is mounted. The source terminal of the switching element Q1, and the drain terminal of the switching element Q2 are mounted to the corresponding lands via bumps BP111 and BP112, respectively. Accordingly, the one end of the wiring pattern 41 corresponds to the node NDO. According to the first embodiment, the wiring pattern 41 does not include the lands to which the switching elements Q1 and Q2 are mounted.

The other end of the wiring pattern 41 is connected with a first inductor-mounting land. The first terminal 201 of the inductor 20 is mounted to the first inductor-mounting land by solder or other means. The first terminal 201 of the inductor 20 is thus electrically and physically connected to the wiring pattern 41. According to the first embodiment, the wiring pattern 41 does not include the land to which the first terminal 201 of the inductor 20 is mounted.

One end of the wiring pattern 42 is spaced from the other end of the wiring pattern 41 by a distance based on the planar shape of the inductor 20. The one end of the wiring pattern 42 is connected with a second inductor-mounting land. The second terminal 202 of the inductor 20 is mounted to the second inductor-mounting land by solder or other means. The second terminal 202 of the inductor 20 is thus electrically and physically connected to the wiring pattern 42. According to the first embodiment, the wiring pattern 42 does not include the land to which the second terminal 202 of the inductor 20 is mounted.

Although not illustrated, the one terminal (high-side terminal) of the output capacitor 32 and the one terminal of the load 82 are each electrically and physically connected to a predetermined position on the wiring pattern 42.

As described above, the first winding 21 is disposed closer to the circuit board 60 than is the second winding 22. In other words, in a direction orthogonal to the surface 61 of the circuit board 60, the second winding 22 is disposed outward of the first winding 21 with reference to the surface 61 of the circuit board 60. In still other words, the first winding 21 is disposed between the second winding 22 and the surface 61 of the circuit board 60.

The one end of the wiring pattern 41 corresponds to the node NDO between the switching element Q1 and the switching element Q2. Accordingly, noise due to the switching operation of the switching elements Q1 and Q2 flows to the wiring pattern 41. That is, the wiring pattern 41 can be said to be a switching node pattern.

The other end of the wiring pattern 41 is connected to the first winding 21. Switching noise thus flows into the first winding 21.

In contrast, one end of the second winding 22 is not directly connected to the node NDO between the switching element Q1 and the switching element Q2, but connected to the node NDO via the first winding 21. Further, the other end of the second winding 22 is connected to the wiring pattern 42. The wiring pattern 42 is connected to the output capacitor 32, and stable in potential. That is, the wiring pattern 42 can be said to be a stable-potential pattern.

As previously mentioned, with reference to the surface 61 of the circuit board 60, the second winding 22, which is connected to the stable-potential pattern, is disposed outward of the first winding 21, which is connected to the switching node pattern. As a result, even when switching noise is radiated from the first winding 21, the presence of the second winding 22 reduces radiation of the switching noise to the external environment of the switching power supply 10.

As illustrated in FIG. 5A, the wiring pattern 41 has an area smaller than the area of the wiring pattern 42. That is, the switching node pattern has an area smaller than the area of the stable-potential pattern. This reduces radiation of switching noise from the wiring pattern 41, which is a source of radiation of the switching noise, to the external environment of the switching power supply 10.

Further, as illustrated in FIG. 5A, for the wiring pattern 41, the reduction of its area is achieved by reducing its length, without reducing its width as much as possible. As a result, the resistive component of the wiring pattern 41 decreases. This makes it possible for the switching power supply 10 to reduce losses due to current, and achieve high-efficiency power conversion. In particular, more efficient power conversion can be achieved for cases where the switching power supply 10 requires high current.

As illustrated in FIG. 5A, the wiring pattern 41 has an area smaller than the area of the inductor 20 as projected on the surface 61 of the circuit board 60 (the projected area of the inductor 20). This configuration of the switching power supply 10 makes it possible to reduce radiation of switching noise to the external environment.

In this regard, the area of the wiring pattern 42 is substantially equal to the projected area of the inductor 20, or larger than the projected area of the inductor 20. This results in the presence of a large stable-potential surface relative to the overall area of the switching power supply 10 in plan view. This in turn makes it possible to reduce the influence of EMI noise (switching noise and common-mode noise) on the external environment of the switching power supply 10.

Further, due to the above-mentioned configuration of the switching power supply 10, switching noise that does not radiate (leak) out to the external environment is confined as described below.

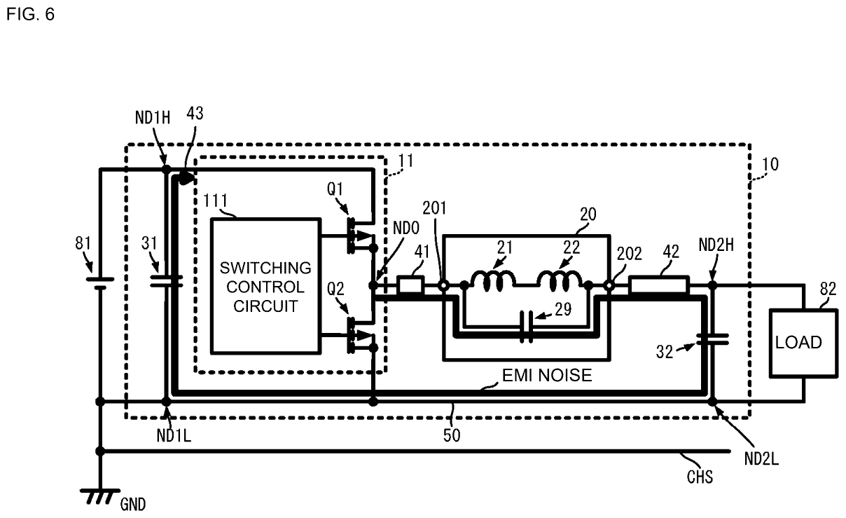

FIG. 6 schematically illustrates the flow of EMI noise in the switching power supply according to the first embodiment of the present disclosure.

As described above, the inductor 20 includes the parasitic capacitor 29, and the parasitic capacitor 29 is connected between the first terminal 201 and the second terminal 202. Accordingly, as indicated by a thick arrow in FIG. 6, switching noise (normal-mode noise) from the node NDO of the switching IC 11 returns to the switching IC 11 via the wiring pattern 41, the parasitic capacitor 29 of the inductor 20, the wiring pattern 42, the output capacitor 32, the reference-potential-side wiring pattern 50, the input capacitor 31, and an input-side high-potential pattern 43. The input-side high-potential pattern 43 refers to a wiring pattern that connects a high-side terminal of the input capacitor 31 to a high-side input terminal (a terminal connected to the drain terminal of the switching element Q1) of the switching IC 11. The input-side high-potential pattern 43 corresponds to an “input wiring pattern.”

That is, the switching power supply 10 includes a closed electric circuit implemented by the following components: the switching IC 11; the wiring pattern 41; the parasitic capacitor 29 of the inductor 20; the wiring pattern 42; the output capacitor 32; the reference-potential-side wiring pattern 50; the input capacitor 31; and the input-side high-potential pattern 43.

Switching noise generated from the switching IC 11 is confined by the closed electric circuit, and common-mode noise generated in the chassis CHS is reduced. Switching noise radiated from the first winding 21 is guided to the closed electric circuit by the second winding 22. Since continuously generated switching noise components are not constant in phase, such noise components cancel each other out when confined within the closed electric circuit. That is, the closed electric circuit functions as a noise-balancing circuit that balances switching noise components to reduce generation of common-mode noise. In other words, the switching power supply 10 includes a noise-balancing circuit.

The above-mentioned configuration allows the switching power supply 10 to reduce generation of common-mode noise by reducing radiation of switching noise to the external environment and conduction of switching noise to the chassis CHS, and to reduce the level of switching noise by means of the noise-balancing circuit. That is, the above-mentioned configuration allows the switching power supply 10 to more effectively reduce radiation of switching noise and generation of common-mode noise. In this case, the switching power supply 10 does not additionally require another member (shield member) for reducing radiation of switching noise and for reducing generation of common-mode noise. This makes it possible to achieve simple configuration and miniaturization.

As described above, the switching power supply 10 is configured to reduce radiation of switching noise. As a result, superimposition of switching noise on the chassis CHS is reduced, and generation of common-mode noise due to switching noise is reduced. This makes it possible to reduce the adverse influence that switching noise may have on various electronics of a vehicle including the chassis CHS.

With a switching power supply 10P according to a comparative configuration that does not include the configuration of the switching power supply 10 according to the first embodiment, common-mode noise flows to the chassis CHS.

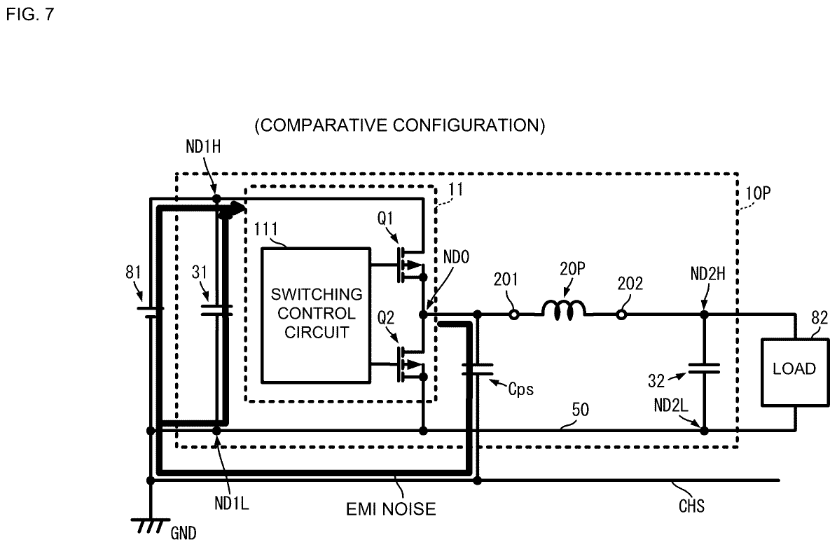

FIG. 7 schematically illustrates the flow of EMI noise in the switching power supply according to the comparative configuration. If the wiring pattern 41 is not configured in the same manner as that of the switching power supply 10 according to the present configuration, then as illustrated in FIG. 7, the switching node pattern that connects to the node NDO of the switching IC 11, and the chassis CHS electrically couple to each other to form a parasitic capacitance Cps. Common-mode noise flows to the chassis CHS through the parasitic capacitance Cps.

As described above, with the switching power supply 10P according to the comparative configuration, common-mode noise leaks to the chassis CHS. Employing the above-mentioned configuration of the switching power supply 10 according to the first embodiment, however, makes it possible to reduce generation (conduction) of common-mode noise caused by coupling of switching noise to the chassis CHS.

The switching power supply 10P according to the comparative configuration includes an inductor 20P that does not employ the configuration of the inductor 20 according to the first embodiment. The inductor 20P includes, for example, a simple winding conductor contained in the magnetic core. With this configuration, switching noise is radiated also from the inductor 20P, and common-mode noise is conducted to the chassis CHS. This may cause an adverse influence on the external environment. The above-mentioned configuration of the inductor 20 mentioned above, however, makes it possible for the switching power supply 10 to reduce radiation of switching noise from the inductor, and reduce conduction of common-mode noise to the chassis CHS.

FIG. 8A is a graph illustrating levels of conducted noise according to the present configuration and the comparative configuration, and FIG. 8B is a graph illustrating levels of radiated noise according to the present configuration and the comparative configuration. Although FIG. 8A depicts only a partial frequency band, noise is distributed similarly for a wider frequency band. In FIGS. 8A and 8B, solid lines represent the noise level according to the present disclosure, and dashed lines represent the noise level according to the comparative configuration. At locations where the noise level according to the present disclosure and the noise level according to the comparative configuration overlap, the noise level according to the present disclosure is depicted as overwriting the noise level according to the comparative configuration.

As illustrated in FIG. 8A, employing the configuration of the switching power supply 10 makes it possible to reduce the level of conducted noise in each frequency band. As illustrated in FIG. 8B, employing the configuration of the switching power supply 10 makes it possible to reduce the level of radiated noise in each frequency band, for example, reduce the level of radiated noise in the 10-MHz band, which is greater than 10 [dBuV/m] according to the comparative configuration, to be less than 10 [dBuV/m].

### Second Embodiment

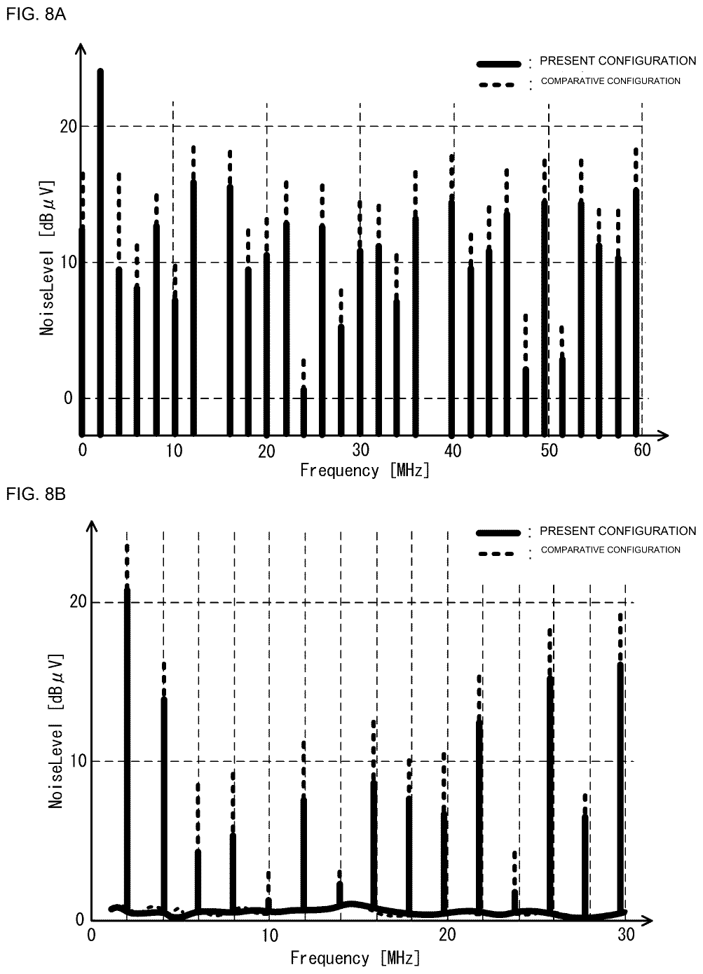

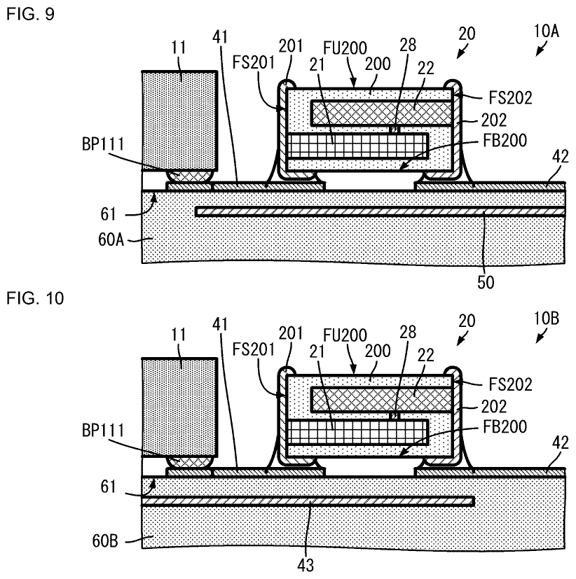

A switching power supply according to a second embodiment of the present disclosure will now be described with reference to the drawings. FIG. 9 is a side cross-sectional view of the switching power supply according to the second embodiment of the present disclosure, illustrating its configuration including a mounting portion where the inductor is mounted.

A switching power supply 10A according to the second embodiment differs from the switching power supply 10 according to the first embodiment with respect to a wiring pattern corresponding to the reference-potential-side wiring pattern 50. Other features of the switching power supply 10A are similar to those of the switching power supply 10, and such similar features will not be described in further detail.

The switching power supply 10A is implemented on a circuit board 60A. The circuit board 60A includes the reference-potential-side wiring pattern 50, which is a conductor pattern.

The reference-potential-side wiring pattern 50 is provided inside the circuit board 60A. The reference-potential-side wiring pattern 50 overlaps the inductor 20 and the wiring pattern 41 in plan view (when viewed in a direction orthogonal to the surface 61).

Due to the configuration mentioned above, a parasitic capacitor is formed between: the inductor 20 and the wiring pattern 41; and the reference-potential-side wiring pattern 50. The main current for power conversion does not flow through the parasitic capacitor. Rather, the parasitic capacitor is of such a capacitance that allows passage therethrough of switching noise, which has a higher frequency than the main current. As a result, switching noise is more effectively confined in the noise-balancing circuit, and generation of common-mode noise is more effectively reduced.

Therefore, the switching power supply 10A makes it possible to more effectively reduce radiation of switching noise to the external environment, and generation and conduction of common-mode noise.

The reference-potential-side wiring pattern 50 may simply overlap part of at least one of the inductor 20 and the wiring pattern 41. Preferably, however, the reference-potential-side wiring pattern 50 overlaps both the inductor 20 and the wiring pattern 41.

### Third Embodiment

A switching power supply according to a third embodiment of the present disclosure will now be described with reference to the drawings. FIG. 10 is a side cross-sectional view of the switching power supply according to the third embodiment of the present disclosure, illustrating its configuration including a mounting portion where the inductor is mounted. FIG. 11 is an equivalent circuit diagram of the switching power supply according to the third embodiment of the present disclosure.

A switching power supply 10B according to the third embodiment differs from the switching power supply 10 according to the first embodiment with respect to a wiring pattern corresponding to the input-side high-potential pattern 43. Other features of the switching power supply 10B are similar to those of the switching power supply 10, and such similar features will not be described in further detail.

As illustrated in FIG. 11, the input-side high-potential pattern 43 is a wiring pattern that connects the node ND1H at the high potential side of the input capacitor 31 to the switching IC 11.

The switching power supply 10B is implemented on a circuit board 60B. The circuit board 60B includes the input-side high-potential pattern 43, which is a conductor pattern.

The input-side high-potential pattern 43 is provided inside the circuit board 60B. The input-side high-potential pattern 43 overlaps the inductor 20 and the wiring pattern 41 in plan view.

Due to the configuration mentioned above, a parasitic capacitor is formed between: the inductor 20 and the wiring pattern 41; and the input-side high-potential pattern 43. The main current for power conversion does not flow through the parasitic capacitor. Rather, the parasitic capacitor is of such a capacitance that allows passage therethrough of switching noise, which has a higher frequency than the main current. As a result, switching noise is more effectively confined in the noise-balancing circuit, and generation of common-mode noise is more effectively reduced.

Therefore, the switching power supply 10B makes it possible to more effectively reduce radiation of switching noise to the external environment, and generation and conduction of common-mode noise.

The input-side high-potential pattern 43 may simply overlap part of at least one of the inductor 20 and the wiring pattern 41. Preferably, however, the input-side high-potential pattern 43 overlaps both the inductor 20 and the wiring pattern 41.

### Fourth Embodiment

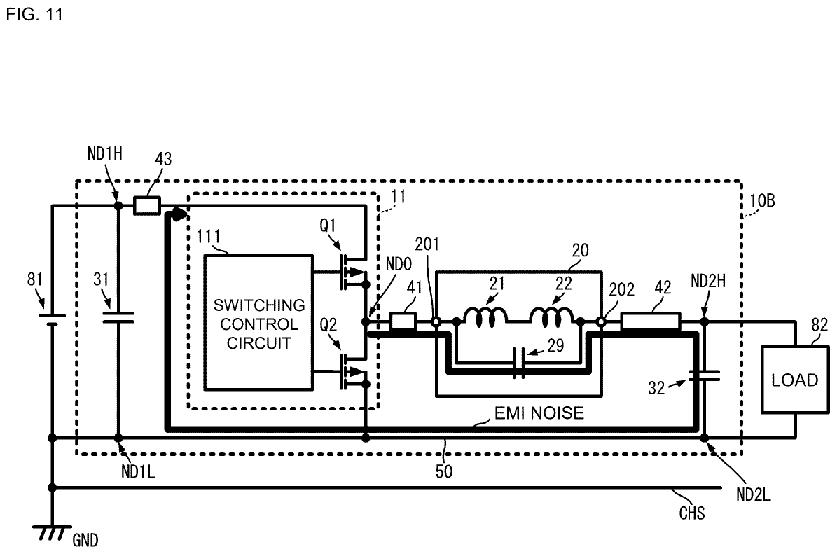

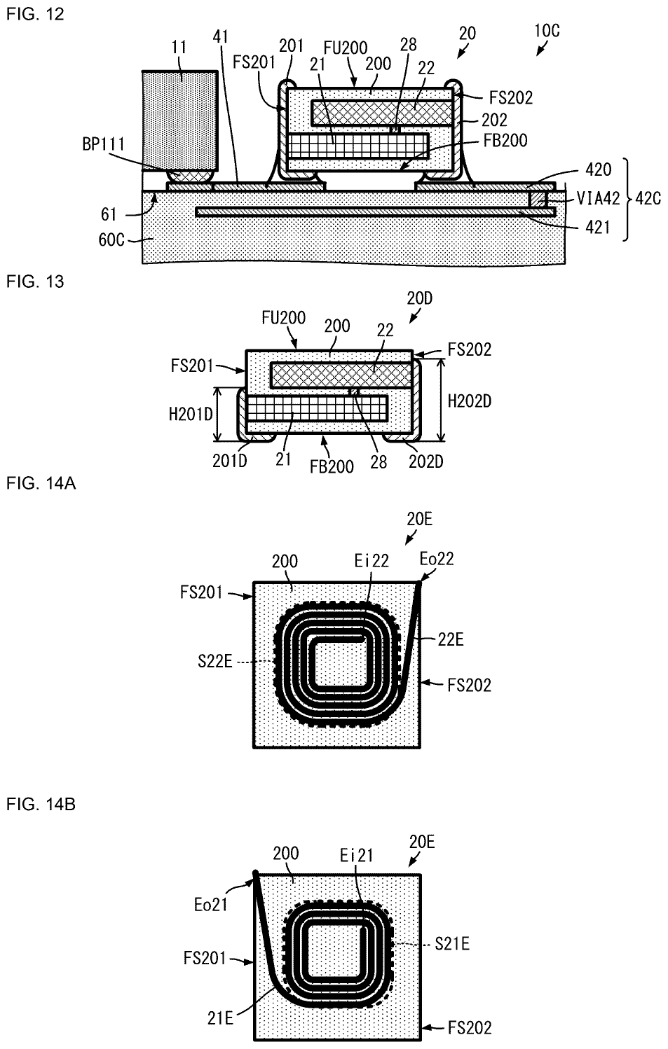

A switching power supply according to a fourth embodiment of the present disclosure will now be described with reference to the drawings. FIG. 12 is a side cross-sectional view of the switching power supply according to the fourth embodiment of the present disclosure, illustrating its configuration including a mounting portion where the inductor is mounted.

A switching power supply 10C according to the fourth embodiment differs from the switching power supply 10 according to the first embodiment with respect to a wiring pattern 42C. Other features of the switching power supply 10C are similar to those of the switching power supply 10, and such similar features will not be described in further detail.

The switching power supply 10C is implemented on a circuit board 60C. The circuit board 60C includes the wiring pattern 42C, which is a conductor pattern.

The wiring pattern 42C includes a wiring pattern 420, a wiring pattern 421, and a connection conductor VIA42. The wiring pattern 420 is provided on the surface 61 of the circuit board 60C. The wiring pattern 420 includes a land for the inductor 20. The wiring pattern 421 is provided inside the circuit board 60C. The wiring pattern 421 is connected to the wiring pattern 420 via the connection conductor VIA42. The wiring pattern 421 overlaps the inductor 20 and the wiring pattern 41 in plan view.

Due to the configuration mentioned above, a parasitic capacitor is formed between: the inductor 20 and the wiring pattern 41; and the wiring pattern 421. The main current for power conversion does not flow through the parasitic capacitor. Rather, the parasitic capacitor is of such a capacitance that allows passage therethrough of switching noise, which has a higher frequency than the main current. As a result, switching noise is more effectively confined in the noise-balancing circuit, and generation of common-mode noise is more effectively reduced.

Therefore, the switching power supply 10C makes it possible to more effectively reduce radiation of switching noise to the external environment, and generation and conduction of common-mode noise.

The wiring pattern 421 may simply overlap part of at least one of the inductor 20 and the wiring pattern 41. Preferably, however, the wiring pattern 421 overlaps both the inductor 20 and the wiring pattern 41.

### Fifth Embodiment

A switching power supply according to a fifth embodiment of the present disclosure will now be described with reference to the drawings. FIG. 13 is a see-through side view of an inductor according to the fifth embodiment of the present disclosure, illustrating the configuration of its winding conductors.

The switching power supply according to the fifth embodiment differs from the switching power supply 10 according to the first embodiment with respect to an inductor 20D. Other features of the switching power supply according to the fifth embodiment are similar to those of the switching power supply 10, and such similar features will not be described in further detail.

As illustrated in FIG. 13, the inductor 20D includes a first terminal 201D, and a second terminal 202D. The first terminal 201D is provided so as to extend over the side face FS201 and the bottom face FB200 of the magnetic core 200. The second terminal 202D is provided so as to extend over the side face FS202 and the bottom face FB200 of the magnetic core 200.

The first terminal 201D has a height H201D lower than a height H202D of the second terminal 202D. The first terminal 201D is provided over the entire width of the side face FS201. The second terminal 202D is provided over the entire width of the side face FS202. As a result, a portion of the first terminal 201D provided on the side face FS201 has a smaller area than a portion of the second terminal 202D provided on the side face FS202. This allows for reduced radiating area for switching noise, and reduced radiation of switching noise from the first terminal 201D.

### Sixth Embodiment

A switching power supply according to a sixth embodiment of the present disclosure will now be described with reference to the drawings. FIGS. 14A and 14B are see-through plan views of an inductor according to the sixth embodiment of the present disclosure, each illustrating the corresponding one of its winding conductors.

The switching power supply according to the sixth embodiment differs from the switching power supply 10 according to the first embodiment with respect to an inductor 20E. Other features of the switching power supply according to the sixth embodiment are similar to those of the switching power supply 10, and such similar features will not be described in further detail.

As illustrated in FIGS. 14A and 14B, the inductor 20E includes a first winding 21E, and a second winding 22E. The second winding 22E has a number of turns greater than the number of turns of the first winding 21E. In plan view, the outer shape of the second winding 22E has an area S22E greater than an area S21E of the outer shape of the first winding 21E.

Further, in plan view, the coiled shape portion of the second winding 22E overlaps the coiled shape portion of the first winding 21E.

The above-mentioned configuration allows the second winding 22E to more effectively reduce radiation of the switching noise from the first winding 21E to the external environment.

### Seventh Embodiment

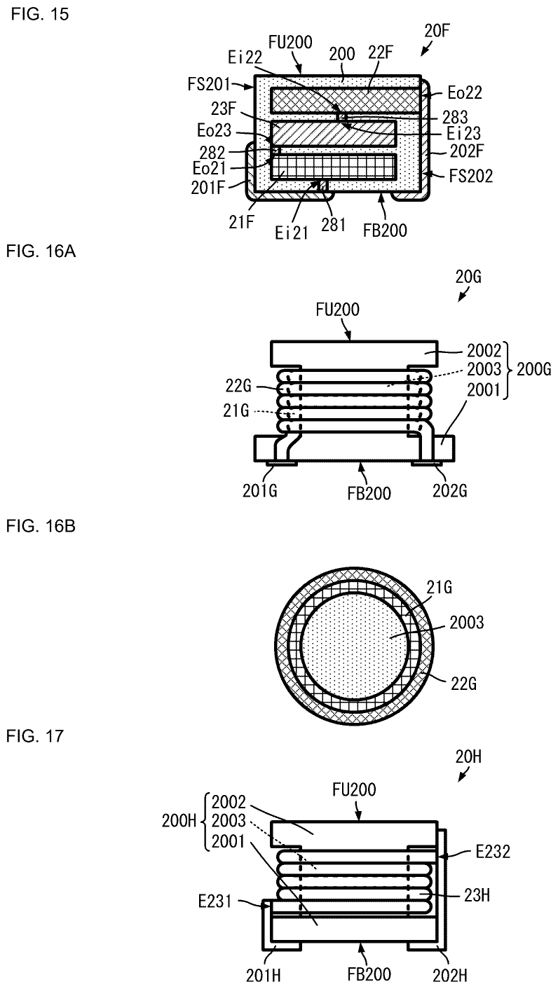

A switching power supply according to a seventh embodiment of the present disclosure will now be described with reference to the drawings. FIG. 15 is a see-through side view of an inductor according to the seventh embodiment of the present disclosure, illustrating the configuration of its winding conductors.

The switching power supply according to the seventh embodiment differs from the switching power supply 10 according to the first embodiment with respect to an inductor 20F. Other features of the switching power supply according to the seventh embodiment are similar to those of the switching power supply 10, and such similar features will not be described in further detail.

As illustrated in FIG. 15, the inductor 20F includes a first winding 21F, a second winding 22F, and a third winding 23F. As with the first winding 21 and the second winding 22 mentioned above, the first winding 21F, the second winding 22F, and the third winding 23F are winding conductors.

The first winding 21F, the second winding 22F, and the third winding 23F are disposed in the following order from the bottom face FB200 of the magnetic core 200 toward the top face FU200: the first winding 21F, the third winding 23F, and the second winding 22F. In other words, the third winding 23F is disposed between the first winding 21F and the second winding 22F.

A first terminal 201F is provided over a side face and the bottom face of the magnetic core 200. The inner end portion Ei21 of the first winding 21F is connected via a connection conductor 281 to a portion (bottom face portion) of the first terminal 201F that is located on the bottom face of the magnetic core 200. More specifically, with the first winding 21F seen in plan view, the inner end of the first winding 21F is connected to a position near the center of the bottom face portion of the first terminal 201F. The first terminal 201F may be provided only on the bottom face of the magnetic core 200.

The outer end portion Eo21 of the first winding 21F is connected via a connection conductor 282 to an outer end portion Eo23 of the third winding 23F. An inner end portion Ei23 of the third winding 23F is connected via a connection conductor 283 to the inner end portion Ei22 of the second winding 22F. The outer end portion Eo22 of the second winding 22F is connected to a second terminal 202F.

As described above, the inductor used in the switching power supply may include three or more winding conductor layers.

In this case, as with the inductor 20F, the first winding 21F, which is closest in the electric circuit to the switching node pattern and the first terminal 201F, is connected at the inner end portion Ei21 to the first terminal 201F and the switching node pattern. The noise level is thus high in the central portion of the inductor 20F in plan view. Therefore, radiation of noise from the inductor 20F to the external environment is more effectively reduced.

### Eighth Embodiment

A switching power supply according to an eighth embodiment of the present disclosure will now be described with reference to the drawings. FIG. 16A is a side view of an inductor according to the eighth embodiment of the present disclosure illustrating its configuration, and FIG. 16B conceptually illustrates the inductor with conductor patterns wound around a magnetic core.

The switching power supply according to the eighth embodiment differs from the switching power supply 10 according to the first embodiment with respect to an inductor 20G. Other features of the switching power supply according to the eighth embodiment are similar to those of the switching power supply 10, and such similar features will not be described in further detail.

The inductor 20G includes a magnetic core 200G, a fourth winding 21G, a fifth winding 22G, a first terminal 201G, and a second terminal 202G.

The magnetic core 200G includes a bottom plate 2001, a top plate 2002, and a support column 2003. The support column 2003 is disposed between the bottom plate 2001 and the top plate 2002, and connected to the bottom plate 2001 and the top plate 2002.

The fourth winding 21G is a winding conductor wound around the support column 2003. One end of the fourth winding 21G is connected to the first terminal 201G provided on the bottom plate 2001.

The fifth winding 22G is a winding conductor wound around the support column 2003 with the fourth winding 21G interposed therebetween. That is, with reference to the support column 2003, the fifth winding 22G is disposed outside the fourth winding 21G. One end of the fifth winding 22G is connected to the other end of the fourth winding 21G. The other end of the fifth winding 22G is connected to the second terminal 202G provided on the bottom plate 2001.

The first terminal 201G is connected to the wiring pattern 41, which is a switching node pattern. The second terminal 202G is connected to the wiring pattern 42, which is a stable-potential pattern.

Employing the inductor 20G configured as described above also makes it possible to provide an operational effect similar to that of the switching power supply 10 employing the inductor 20 described above.

### Ninth Embodiment

A switching power supply according to a ninth embodiment of the present disclosure will now be described with reference to the drawings. FIG. 17 is a side view of an inductor according to the ninth embodiment of the present disclosure illustrating its configuration.

The switching power supply according to the ninth embodiment differs from the switching power supply 10 according to the first embodiment with respect to an inductor 20H. Other features of the switching power supply according to the ninth embodiment are similar to those of the switching power supply 10, and such similar features will not be described in further detail.

The inductor 20H includes a magnetic core 200H, a sixth winding 23H, a first terminal 201H, and a second terminal 202H.

The magnetic core 200H includes the bottom plate 2001, the top plate 2002, and the support column 2003. The support column 2003 is disposed between the bottom plate 2001 and the top plate 2002, and connected to the bottom plate 2001 and the top plate 2002.

The first terminal 201H is provided so as to extend from the bottom face of the bottom plate 2001 to one side face of the bottom plate 2001. The second terminal 202H is provided so as to extend from a bottom face of the bottom plate 2001 to the other side face of the bottom plate 2001. The second terminal 202H is of such a height that the second terminal 202H reaches the top plate 2002.

The sixth winding 23H is a winding conductor wound around the support column 2003. The sixth winding 23H includes one end portion E231, and the other end portion E232. The one end portion E231 is adjacent to the bottom plate 2001, and the other end portion E232 is adjacent to the top plate 2002.

The one end portion E231 is connected to the first terminal 201H. The other end portion E323 is connected to the second terminal 202H.

Due to the configuration mentioned above, the one end portion E231, which is located at the lower side in the height direction of the sixth winding 23H, is connected to the wiring pattern 41 (switching node pattern). The other end portion E232, which is located at the upper side in the height direction of the sixth winding 23H, is connected to the wiring pattern 42 (stable-potential pattern). In other words, the one end portion E231 of the sixth winding 23H is located closer to the circuit board 60 than is the other end portion E232.

Employing the inductor 20H configured as described above also makes it possible to provide an operational effect similar to that of the switching power supply 10 employing the inductor 20 described above.

### Tenth Embodiment

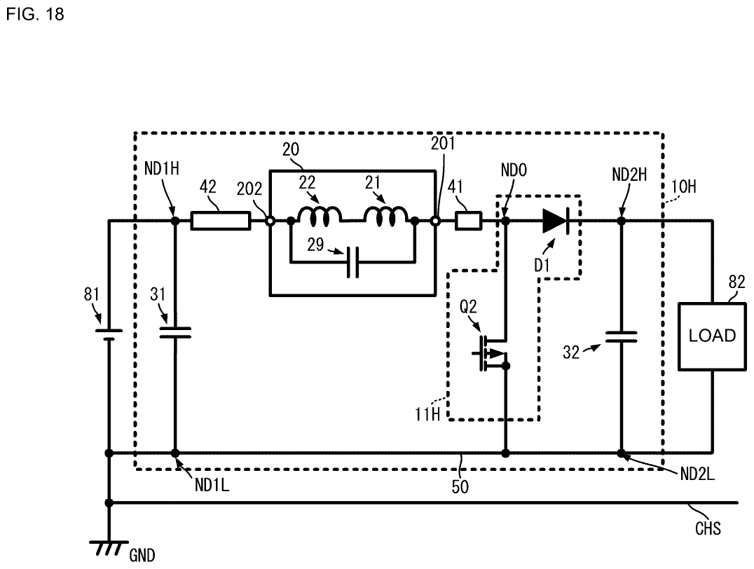

A switching power supply according to a tenth embodiment of the present disclosure will now be described with reference to the drawings. FIG. 18 is a circuit diagram illustrating a schematic configuration of the switching power supply according to the tenth embodiment of the present disclosure.

Although the switching power supply 10 according to the first embodiment is a step-down DC-DC converter, a switching power supply 10H according to the tenth embodiment is a step-up DC-DC converter. In the switching power supply 10H, the configuration of the inductor 20, and the respective shapes of the wiring pattern 41 and the wiring pattern 42 are similar to those in the switching power supply 10.

As illustrated in FIG. 18, the switching power supply 10H includes a switching IC 11H, the inductor 20, the input capacitor 31, and the output capacitor 32. The switching IC 11H includes a switching control circuit (not illustrated), a switching element D1, and the switching element Q2. The switching element D1 corresponds to the “first switching element”, and the switching element Q2 corresponds to the “second switching element.” The switching element D1 and the switching element Q2 are power semiconductor elements.

The switching power supply 10H is electrically connected to the direct-current power source 81, and electrically connected to the load 82.

More specifically, the input capacitor 31 is electrically connected in parallel with the direct-current power source 81. The connection point between the positive terminal of the direct-current power source 81 and the input capacitor 31 is the node ND1H, and the connection point between the negative terminal of the direct-current power source 81 and the input capacitor 31 is the node ND1L.

The switching element D1 and the switching element Q2 are electrically connected in series with each other. More specifically, the anode of the switching element D1, and the drain of the switching element Q2 are electrically connected to each other. The connection point between the switching element D1 and the switching element Q2 is the node NDO.

The wiring pattern 42 is connected to the node ND1L. The second terminal 202 of the inductor 20 is connected to the wiring pattern 42. The wiring pattern 41 is connected to the first terminal 201 of the inductor 20. The wiring pattern 41 is connected to the node NDO.

The one terminal (high-side terminal) of the output capacitor 32 is connected to the cathode of the switching element D1. The connection point between the cathode of the switching element D1 and the one terminal of the output capacitor 32 is the node ND2H.

The other terminal (low-side terminal) of the output capacitor 32 is connected to the reference-potential-side wiring pattern 50. The connection point between the other terminal of the output capacitor 32 and the reference-potential-side wiring pattern 50 is the node ND2L.

The reference-potential-side wiring pattern 50 is connected to the node ND1L (the connection point between the negative terminal of the direct-current power source 81 and the input capacitor 31).

The configuration mentioned above makes it possible to implement, in the switching power supply 10H, a noise-balancing circuit including the following components: the wiring pattern 41, the inductor 20, the wiring pattern 42, the input capacitor 31, the reference-potential-side wiring pattern 50, and the output capacitor 32. As a result, as with the switching power supply 10, the switching power supply 10H makes it possible to reduce radiation of switching noise to the external environment, and generation and conduction of common-mode noise, and also reduce noise level by means of the noise-balancing circuit. Therefore, the switching power supply 10H makes it possible to more effectively reduce radiation of switching noise to the external environment, and generation and conduction of common-mode noise.

For the switching power supply 10 according to each of the above-mentioned embodiments, the common-mode noise reduction effect can be verified as follows, for example.

In a first example, a Delta-type LISN is connected to the wiring pattern at each of the positive and negative sides of the direct-current power source 81, and a spectrum analyzer is connected to the Delta-type LISN. By measuring the output voltage of the Delta-type LISN with the spectrum analyzer, the common-mode noise reduction effect can be verified.

In a second example, a current sensor (current probe) is connected to the wiring pattern at each of the positive and negative sides of the direct-current power source 81, and a spectrum analyzer is connected to the current sensor. By measuring the output current of the current sensor with the spectrum analyzer, the common-mode noise reduction effect can be verified.

In a third example, a LISN is connected to the wiring pattern at the negative side of the direct-current power source 81, and the LISN is connected to the chassis CHS. A current sensor (current probe) is placed on the connection line between the LISN and the chassis CHS, and a spectrum analyzer is connected to the current sensor. By measuring the output current of the current sensor with the spectrum analyzer, the common-mode noise reduction effect can be verified.

The configurations according to the above-mentioned embodiments can be combined as appropriate to provide operational effects corresponding to individual combinations.
<1> A switching power supply comprising an input capacitor; a first switching element and a second switching element that are electrically connected to the input capacitor; an inductor including a first terminal and a second terminal; an output capacitor; and a circuit board to which the input capacitor, the first switching element, the second switching element, the inductor, and the output capacitor are mounted. The circuit board includes a first wiring pattern that electrically connects a connection node between the first switching element and the second switching element to the first terminal, and a second wiring pattern that electrically connects the second terminal to the output capacitor. The inductor includes a first winding disposed near the circuit board, a second winding that is disposed farther from the circuit board than is the first winding, and that is connected in series with the first winding, and a magnetic core in which the first winding and the second winding are contained. The first winding being electrically connected to the first terminal, the second winding being electrically connected to the second terminal. The first wiring pattern has an area smaller than a projected area of the inductor in physical size. Also, the second wiring pattern has an area substantially equal to or larger than the projected area of the inductor in physical size. The input capacitor, the first wiring pattern, the second wiring pattern, and the output capacitor constitute a noise-balancing circuit formed by a closed electric circuit, the noise-balancing circuit being configured to cancel generation of electromagnetic noise caused by switching operation of the first switching element and the second switching element and to reduce generation of common-mode noise radiated from the first winding of the inductor.
<2> The switching power supply according to <1>, wherein the circuit board includes a reference potential pattern that provides a reference potential for the switching power supply. Also, in plan view of the circuit board, the reference potential pattern is provided in a region that overlaps a region where the inductor is mounted.
<3> The switching power supply according to <1> or <2>, wherein the circuit board includes an input wiring pattern that electrically connects to the input capacitor. Also, wherein in plan view of the circuit board, the input wiring pattern is provided in a region that overlaps a region where the inductor is mounted.
<4> The switching power supply according to any one of <1> to <3>, wherein in plan view of the circuit board, a portion of the second wiring pattern is provided in a region that overlaps a region where the inductor is mounted.
<5> The switching power supply according to any one of <1> to <4>, wherein the magnetic core has a bottom face, a first side face, and a second side face. Also, the first terminal is provided to extend over the bottom face and the first side face, and the second terminal is provided to extend over the bottom face and the second side face. In addition, a portion of the first terminal provided on the first side face has a smaller area than a portion of the second terminal provided on the second side face.
<8> The switching power supply according to any one of <1> to <5>, wherein in plan view of the inductor, the second winding has an outer shape larger than an outer shape of the first winding.
<7> The switching power supply according to any one of <1> to <6>, wherein the inductor includes at least one third winding electrically connected between the first winding and the second winding. Also, the first winding has an inner end electrically connected to the first terminal, and the second winding has an outer end electrically connected to the second terminal.
<8> A switching power supply comprising an input capacitor; a first switching element and a second switching element that are electrically connected to the input capacitor; an inductor including a first terminal and a second terminal; an output capacitor; and a circuit board to which the input capacitor, the first switching element, the second switching element, the inductor, and the output capacitor are mounted. The circuit board includes a first wiring pattern that electrically connects a connection node between the first switching element and the second switching element to the first terminal, and a second wiring pattern that electrically connects the second terminal to the output capacitor. Also, the inductor includes a magnetic core having a columnar shape, a fourth winding wound around the magnetic core, and a fifth winding that is wound around the magnetic core at a position outward of the fourth winding, and that is connected in series with the fourth winding. In addition, the fourth winding being electrically connected to the first terminal, the fifth winding being electrically connected to the second terminal. The first wiring pattern has an area smaller than an area of the second wiring pattern. The input capacitor, the first wiring pattern, and the second wiring pattern constitute a noise-balancing circuit formed by a closed electric circuit, the noise-balancing circuit being substantially equal to the inductor in physical size and configured to reduce generation of common-mode noise radiated from the third winding of the inductor.
<9> A switching power supply comprising an input capacitor; an inductor including a first terminal and a second terminal; a first switching element and a second switching element that are electrically connected to the inductor; an output capacitor; and a circuit board to which the input capacitor, the first switching element, the second switching element, the inductor, and the output capacitor are mounted. The circuit board includes a first wiring pattern that electrically connects a connection node between the first switching element and the second switching element to the first terminal, and a second wiring pattern that electrically connects the second terminal to the input capacitor. The inductor includes a first winding disposed near the circuit board, a second winding that is disposed farther from the circuit board than is the first winding, and that is connected in series with the first winding, and a magnetic core in which the first winding and the second winding are contained. The first winding being electrically connected to the first terminal, the second winding being electrically connected to the second terminal. Also, the first wiring pattern has an area smaller than a projected area of the inductor in physical size, and the second wiring pattern has an area substantially equal to or larger than the projected area of the inductor in physical size. In addition, the input capacitor, the second wiring pattern, and the output capacitor constitute a noise-balancing circuit formed by a closed electric circuit, the noise-balancing circuit being configured to cancel generation of electromagnetic noise caused by switching operation of the first switching element and the second switching element and to reduce generation of common-mode noise radiated from the first winding of the inductor.
<10> A switching power supply comprising an input capacitor; a first switching element and a second switching element that are electrically connected to the input capacitor; an inductor including a first terminal and a second terminal; an output capacitor; and a circuit board to which the input capacitor, the first switching element, the second switching element, the inductor, and the output capacitor are mounted. The circuit board includes a first wiring pattern that electrically connects a connection node between the first switching element and the second switching element to the first terminal, and a second wiring pattern that electrically connects the second terminal to the output capacitor. The inductor includes a sixth winding including one end portion that is electrically connected to the first terminal, and an other end portion that is electrically connected to the second terminal, and a magnetic core around which the sixth winding is to be wound. The one end portion of the sixth winding is disposed closer to the circuit board than is the other end portion of the sixth winding. Also, the first wiring pattern has an area smaller than a projected area of the inductor in physical size, and the second wiring pattern has an area substantially equal to or larger than the projected area of the inductor in physical size. The input capacitor, the first wiring pattern, the second wiring pattern, and the output capacitor constitute a noise-balancing circuit formed by a closed electric circuit, the noise-balancing circuit being configured to cancel generation of electromagnetic noise caused by switching operation of the first switching element and the second switching element and to reduce generation of common-mode noise radiated from the first winding of the inductor.

What is claimed is:

1. A switching power supply comprising:
an input capacitor;
a first switching element and a second switching element that are electrically connected to the input capacitor;
an inductor including a first terminal and a second terminal;
an output capacitor; and
a circuit board to which the input capacitor, the first switching element, the second switching element, the inductor, and the output capacitor are mounted,
wherein
the circuit board includes
a first wiring pattern that electrically connects a connection node between the first switching element and the second switching element to the first terminal, and
a second wiring pattern that electrically connects the second terminal to the output capacitor,
the inductor includes
a first winding near the circuit board,
a second winding that is farther from the circuit board than is the first winding, and that is connected in series with the first winding, and
a magnetic core in which the first winding and the second winding are contained,
the first winding being electrically connected to the first terminal, the second winding being electrically connected to the second terminal,
the first wiring pattern has an area smaller than a projected area of the inductor in physical size,
the second wiring pattern has an area substantially equal to or larger than the projected area of the inductor in physical size, and
the input capacitor, the first wiring pattern, the second wiring pattern, and the output capacitor configure a noise-balancing circuit as a closed electric circuit.

2. The switching power supply according to claim 1, wherein
the circuit board includes a reference potential pattern configured to provide a reference potential for the switching power supply, and
in plan view of the circuit board, the reference potential pattern is in a region that overlaps a region where the inductor is mounted.

3. The switching power supply according to claim 1, wherein
the circuit board includes an input wiring pattern that electrically connects to the input capacitor, and
in plan view of the circuit board, the input wiring pattern is in a region that overlaps a region where the inductor is mounted.

4. The switching power supply according to claim 1, wherein
in plan view of the circuit board, a portion of the second wiring pattern is in a region that overlaps a region where the inductor is mounted.

5. The switching power supply according to claim 1, wherein
the magnetic core has a bottom face, a first side face, and a second side face,
the first terminal extends over the bottom face and the first side face,
the second terminal extends over the bottom face and the second side face, and
a portion of the first terminal on the first side face has a smaller area than a portion of the second terminal on the second side face.

6. The switching power supply according to claim 1, wherein
in plan view of the inductor, the second winding has an outer shape larger than an outer shape of the first winding.

7. The switching power supply according to claim 1, wherein
the inductor includes at least one third winding electrically connected between the first winding and the second winding,
the first winding has an inner end electrically connected to the first terminal, and
the second winding has an outer end electrically connected to the second terminal.

8. The switching power supply according to claim 2, wherein
the circuit board includes an input wiring pattern that electrically connects to the input capacitor, and
in plan view of the circuit board, the input wiring pattern is in a region that overlaps a region where the inductor is mounted.

9. The switching power supply according to claim 2, wherein
in plan view of the circuit board, a portion of the second wiring pattern is in a region that overlaps a region where the inductor is mounted.

10. The switching power supply according to claim 2, wherein
the magnetic core has a bottom face, a first side face, and a second side face,
the first terminal extends over the bottom face and the first side face,
the second terminal extends over the bottom face and the second side face, and
a portion of the first terminal on the first side face has a smaller area than a portion of the second terminal on the second side face.

11. The switching power supply according to claim 2, wherein
in plan view of the inductor, the second winding has an outer shape larger than an outer shape of the first winding.

12. The switching power supply according to claim 2, wherein
the inductor includes at least one third winding electrically connected between the first winding and the second winding,
the first winding has an inner end electrically connected to the first terminal, and
the second winding has an outer end electrically connected to the second terminal.

13. A switching power supply comprising:
an input capacitor;
a first switching element and a second switching element that are electrically connected to the input capacitor;
an inductor including a first terminal and a second terminal;
an output capacitor; and
a circuit board to which the input capacitor, the first switching element, the second switching element, the inductor, and the output capacitor are mounted,
wherein
the circuit board includes
a first wiring pattern that electrically connects a connection node between the first switching element and the second switching element to the first terminal, and
a second wiring pattern that electrically connects the second terminal to the output capacitor,
the inductor includes
a magnetic core having a columnar shape,
a fourth winding wound around the magnetic core, and
a fifth winding that is wound around the magnetic core at a position outward of the fourth winding, and that is connected in series with the fourth winding,
the fourth winding being electrically connected to the first terminal, the fifth winding being electrically connected to the second terminal,
the first wiring pattern has an area smaller than an area of the second wiring pattern, and
the input capacitor, the first wiring pattern, and the second wiring pattern configure a noise-balancing circuit as a closed electric circuit, the noise-balancing circuit being substantially equal to the inductor in physical size.

14. A switching power supply comprising:
an input capacitor;
an inductor including a first terminal and a second terminal;
a first switching element and a second switching element that are electrically connected to the inductor;
an output capacitor; and
a circuit board to which the input capacitor, the first switching element, the second switching element, the inductor, and the output capacitor are mounted,
wherein
the circuit board includes
a first wiring pattern that electrically connects a connection node between the first switching element and the second switching element to the first terminal, and
a second wiring pattern that electrically connects the second terminal to the input capacitor,
the inductor includes
a first winding near the circuit board,
a second winding that is farther from the circuit board than is the first winding, and that is connected in series with the first winding, and
a magnetic core in which the first winding and the second winding are contained,
the first winding being electrically connected to the first terminal, the second winding being electrically connected to the second terminal,
the first wiring pattern has an area smaller than a projected area of the inductor in physical size,
the second wiring pattern has an area substantially equal to or larger than the projected area of the inductor in physical size, and
the input capacitor, the second wiring pattern, and the output capacitor configure a noise-balancing circuit as a closed electric circuit.

15. A switching power supply comprising:
an input capacitor;
a first switching element and a second switching element that are electrically connected to the input capacitor;
an inductor including a first terminal and a second terminal;
an output capacitor; and
a circuit board to which the input capacitor, the first switching element, the second switching element, the inductor, and the output capacitor are mounted,
wherein
the circuit board includes
a first wiring pattern that electrically connects a connection node between the first switching element and the second switching element to the first terminal, and
a second wiring pattern that electrically connects the second terminal to the output capacitor,
the inductor includes
a sixth winding including one end portion that is electrically connected to the first terminal, and an other end portion that is electrically connected to the second terminal, and
a magnetic core around which the sixth winding is to be wound,
the one end portion of the sixth winding is closer to the circuit board than is the other end portion of the sixth winding,
the first wiring pattern has an area smaller than a projected area of the inductor in physical size,
the second wiring pattern has an area substantially equal to or larger than the projected area of the inductor in physical size, and
the input capacitor, the first wiring pattern, the second wiring pattern, and the output capacitor configure a noise-balancing circuit as a closed electric circuit.
